(19) United States
(12) Patent Application Publication
(10) Pub. No.: US 2003/0014306 A1
(43) Pub. Date: Jan. 16, 2003

(54) Method and system for providing coupons

(76) Inventor: Kurt R. Marko, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/905,323

(22) Filed: Jul. 13, 2001

(51) Int. Cl. G06F 17/60

(52) U.S. Cl. 705/14

(57) ABSTRACT

A method and system are described for selecting and printing a coupon based on an expected value of the coupon to a retailer. A processor determines the expected value of a coupon based on a comparison between items in a transaction and a predictor set of items in a correlation data structure. The expected value is assigned to the coupon when the predictor set is contained in the transaction. Coupons are ranked, selected and printed to a transaction record based on the expected value.

### FIELD OF THE INVENTION

The present invention relates generally to coupons, and more particularly to a method and system for providing coupons with high expected value to a retailer based on characteristics of items in a current transaction.

### BACKGROUND OF THE INVENTION

Digital identification and analysis of consumer transactions and behavior have effected profound changes for both consumers and retailers over the past decade. For example, scanners for item identification at a point-of-sale (POS) are capable of rapidly recognizing a product identity code and converting this code into digital information. This digital information is sent to a processor and compared with a digital record of all items in an item database to identify the specific product and its price. The product identity and price of the various items are then used by the processor to produce a transaction record that includes a description of each item in a transaction, the item's price, and the total cost of all items in the transaction. Typically, a printer connected to the processor, and near the scanner, prints a hard copy of the transaction record as a receipt. Both the consumer and the retailer benefit from this rapid and accurate system of determining the total cost of the transaction.

This method of identifying and recording transactions in digital form can provide a valuable resource to retailers. In particular, the resulting records of consumer purchasing patterns has the potential to greatly aid the retailer in making marketing decisions, in merchandise stocking, and in manufacturer selection. Unfortunately, the amount of information obtained may be overwhelming and countless methods are available for extracting patterns or trends from this information. Therefore, there has been little progress in providing straightforward, practical uses for this wealth of information.

One method, described in U.S. Pat. No. 4,910,672 of Mindrum et al. and U.S. Pat. No. 4,723,212 of Off et al., attempts to use the digital transaction record to provide targeted marketing to consumers. A discount coupon is issued to a consumer based on the presence of a “triggering” item in a transaction. The triggering item is the same product that is offered by the discount coupon, but produced by a different manufacturer.

This method suffers from a number of disadvantages. First, this method offers a coupon for the same item that the consumer has just purchased. The consumer is unlikely to need a second, essentially equivalent item from a distinct manufacturer until a future time when the first item has been consumed. At this future time the coupon may have been misplaced, discarded, or simply forgotten. A second disadvantage is that this method offers the coupon to someone that is already a user of the similar product. Therefore, this method may not expand the size of the customer base for the coupon product, which is frequently an important goal of manufacturers. Finally, this method does not take advantage of information derived from prior transactions. Instead, a coupon is offered based only on the current items in the transaction, without considering how this transaction record might predict coupon use or value in view of prior transaction trends.

There have also been efforts to use information from prior transactions to provide targeted incentives to a customer at the POS. For example, U.S. Pat. No. 5,056,019 to Schultz et al. and U.S. Pat. No. 5,832,457 to O'Brien et al. provide either a reward or a discount coupon based on the prior purchasing behavior of the customer. However, these systems are difficult to implement because they require identification of the customer during the transaction. In addition, these systems rely primarily on rewarding repeat behavior of the customer. Therefore, they do not expand the set of products that the consumer purchases. Furthermore, these systems do not take advantage of a transaction database containing transaction records of other consumers.

Efforts to provide a general framework for computer analysis and human understanding of transaction databases have focused on development of “association rules”. The rationale for these rules and computer-based methods for their identification are described in U.S. Pat. No. 5,615,341 to Agrawal et al., which is hereby incorporated by reference. The association rules set forth in this patent identifies frequent associations between items or sets of items in transactions, but there has heretofore not been a practical use for these rules. The present invention provides a method and system to apply association rules, or other observed consumer behaviors, to coupon selection based on items in a current transaction.

### SUMMARY OF THE INVENTION

The present invention involves a method for selecting a coupon based on an expected value of the coupon to a retailer. The method includes the steps of identifying items in a current transaction, determining a value of one or more coupons based on the items in the current transaction, and selecting the coupon based on comparative values of the coupons. Typically, a coupon with high expected value is selected from among a set of potential coupons, based on the items in the current transaction.

### BRIEF DESCRIPTION OF THE FIGURES

FIG. 1 is an isometric illustration of a system for providing coupons in accordance with the present invention.

FIG. 2 is a plan view of a printed coupon that has been produced in accordance with the present invention.

FIG. 3 is block diagram of the system of FIG. 1 included as part of a larger network, in accordance with the present invention.

FIG. 4 is a schematic representation of a data structure used for assigning expected value in accordance with the present invention.

FIG. 5 is a flowchart showing a method of providing coupons in accordance with the present invention.

### DETAILED DESCRIPTION OF THE INVENTION

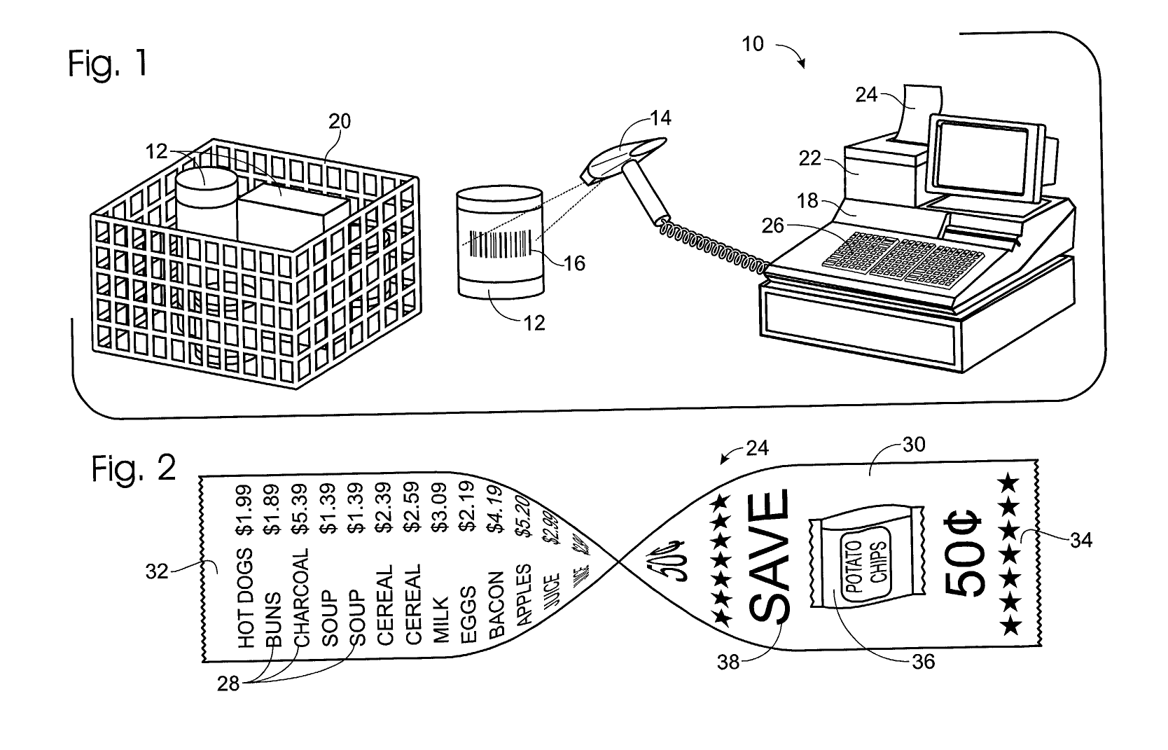

The present invention provides a method and system for selecting a coupon for a consumer at a point-of-sale (POS) based on items in a current transaction. FIG. 1 shows an exemplary system 10 configured for carrying out the invention. In practicing the invention, each item 12 in a transaction is identified by a retailer at a POS with a scanner 14 configured to read identifying information, such as a barcode 16 on item 12. Scanner 14 sends the identity of each item 12 to a processor 18. Processor 18 compares association rules in memory with patterns evident from identifying items 12 from a consumer's basket 20 to select a coupon with high expected value for the retailer. An image of the selected coupon is then sent to an output device such as printer 22, which prints a transaction record 24, typically a receipt, with the coupon linked to the transaction record. A user interface 26 may allow a user of the system 10 to input additional information and/or to regulate the activity of scanner 14, printer 22, and processor 18.

Items 12 include anything that can be purchased from a seller, including goods or services. When items 12 are identified, they typically are given general identities for further analysis by processor 18 in accordance with the invention. For example, if a consumer purchases Brand X or Brand Y hot dogs, each might be represented within processor 18 by a single identifier for comparison with items in memory. However, a precise identity of each item is also stored in processor 18 to calculate the cost of the transaction to the consumer and to produce transaction record 24.

Scanner 14 includes any input device capable of identifying items 12 in a transaction. Typically scanner 14 is an optical scanner that reads identifying information, such as barcode 16. However, inputting item identity may be carried out in any suitable way including using an imaging system that recognizes the overall appearance of a product or any other identifying information on the item. Alternatively, or in addition, manual entry of item identifying information may be conducted through a keypad such as interface 26.

Processor 18 is any processing device capable of receiving, storing, retrieving, manipulating, and sending data that is related to item identification and a correlation data structure (see below). Typically, processor 18 is a computer with memory, a central processing unit, and follows instructions, generally in the form of a computer program. It should be understood that the present invention may be carried out with a single processor or with more than one processor linked in network communication.

Basket 20 is broadly intended to describe a complete set of items in a current transaction. Therefore, generally, purchase of a basket 20 by the consumer is a transaction. Printer 22 is any output device capable of providing a consumer with a transaction record 24.

Interface 26 is any point of interaction between a user, scanner 14, processor 18, and printer 22. Typically, interface 26 is a keypad, keyboard, or some other manually-operated system through which a user informs processor 18 of a beginning and an end of a transaction. In addition, interface 26 may regulate operation of printer 22 in printing transaction record 24 and may interface with a payment mechanism used by the consumer during the transaction. However, in more automated systems, interface 26 may be incorporated into scanner 14 (or printer 22). For example, a specific scannable code may signal the beginning and the end of a transaction.

As shown in FIG. 2, transaction record 24 typically includes a list 28 of all items 12 purchased by the consumer along with each item's purchase price and at least one coupon 30 printed to available space on transaction record 24. In this case, list 28 is printed on a front side 32 and coupon 30 is printed on a back side 34 of transaction record 24. However, coupon 30 may be printed on front side 32 of transaction record 24, either above, below, or interspersed with list 28. Coupon 30 is offered to the consumer for use in a subsequent transaction, and typically identifies a subject item 36 by brand name and coupon redemption information 38.

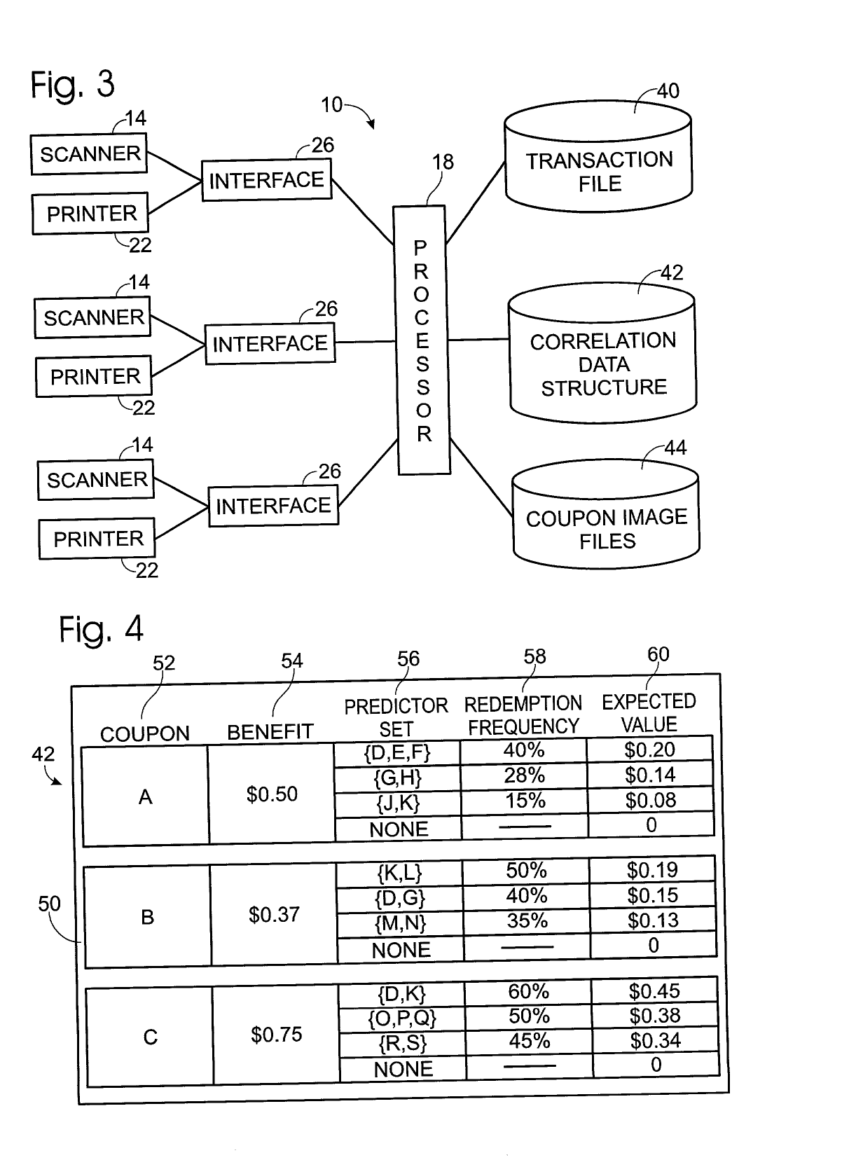

FIG. 3 is a somewhat schematic depiction of system 10 of FIG. 1, showing three interfaces 26, each with a linked scanner 14 and printer 22. Each interface 26 is operatively linked to processor 18 and configured to send information to, and receive information from, processor 18. It is important to note that processor 18 may be linked to any suitable number of interfaces with associated scanners and printers. In addition, printer and scanner may be shared between one or more interfaces. Those skilled in the art will recognize that interface 26, scanner 14, printer 22, and processor 18 may be operatively connected by any suitable configuration that allows them to communicate information, when required.

As scanner 14 scans items, a digital record for each item is communicated to processor 18 where the digital record is stored in an onboard memory as part of a transaction file 40. Processor 18 thus creates and stores transaction file 40 corresponding to the items identified in basket 20. As described above, transaction file 40 typically includes a general identity of each item that may be brand-independent. Transaction file 40 is then related to correlation data structure 42 to assign an expected value to each coupon in correlation data structure 42. Processor 18 then typically ranks each coupon to give it a relative rank according to its assigned expected value, and selects one or more coupons 30 based on the relative rank of each coupon present in correlation data structure 42. A corresponding coupon image from coupon image files 44 then may be retrieved, and the image sent to an output device, typically printer 22, which prints selected coupon 30 on transaction record 24.

A specific example of correlation data structure 42 stored in memory 50 of processor 18 is shown in FIG. 4. Correlation data structure 42 is provided prior to the transaction and includes coupons 52, listed here as A, B, and C, which have been selected for potential offer to each consumer based on the items identified in the consumer's basket. Coupon 52 is a virtual representation of coupon 30 and corresponds to subject item 36. Coupon 30 is produced from coupon 52 by printing a coupon image file or a text version of coupon 30. The consumer may obtain coupon item 36 in a subsequent transaction by redeeming physical coupon 30. Coupon redemption includes presenting coupon 30, and meeting any requirements of coupon 30, such as paying an amount for coupon item 36 that is at least partially dictated by coupon 30.

Associated with each coupon in correlation data structure 42 is a benefit realized by the retailer upon redemption of coupon 30 by the consumer. Typically, redemption of coupon 30 includes transacting a subject item of the coupon. In the example of FIG. 4, coupons A, B, and C, shown at 52, have benefits shown in benefit column 54 of $0.50, $0.37, and $0.75, respectively. The benefit of each coupon to the retailer is any retailer benefit derived from redemption by the consumer, including profit margin, profit ratio, manufacturer's incentive, or space made available for other inventory. Thus, the benefit may indicate a direct monetary benefit, as in FIG. 4, or may be stated in arbitrary units provided by the retailer. In the example of FIG. 4, the benefit is a profit received upon coupon redemption, and is calculated as a purchase price paid by the consumer upon coupon redemption minus a cost to the retailer of providing coupon item 36. For example, if coupon item A (for coupon A) has a cost to the retailer of $1.25 and the coupon for item A is redeemed by the consumer for $1.75, the benefit to the retailer is $0.50.

Each coupon of correlation data structure 42 has one or more linked predictor sets 56. Predictor set 56 is a set of one or more items (represented by A-Z) that, when identified in a current transaction, estimate a redemption frequency 58 for a coupon. For example, FIG. 4 lists predictor sets {D, E, F}, {G, H}, and {J, K} for coupon A with redemption frequencies of 40%, 28%, and 15%, respectively. Each paired redemption frequency 58 and predictor set 56 for coupon 52 is typically derived from an association rule, as described more fully below. Redemption frequency 58 is the likelihood of coupon redemption by a consumer, based on the presence of the items of predictor set 56 in a current transaction. Thus, a current transaction that consists of items A-F contains or includes predictor set {D, E, F} and thus assigns a redemption frequency of 40% to coupon A. This means that a consumer purchasing items A-F is predicted to redeem coupon A approximately 40% of the time in a future transaction. It is important to note that redemption frequency 58 is usually only an estimate of an actual frequency of redemption by the consumer. Thus, redemption frequency 58 may be considered more accurately as a relative indication of a frequency of coupon redemption by the consumer.

Also associated with redemption frequency 58 of predictor set 56 is an expected value 60. Expected value 60 is a function of benefit 54 combined with redemption frequency 58. Typically, expected value 60 is derived as the product of benefit 54 multiplied by redemption frequency 58. Thus, as exemplified in FIG. 4, when predictor set {D, E, F} is present in a transaction, a predicted redemption frequency of 40% (0.40) multiplied by a benefit of $0.50 produces an assigned expected value of $0.20 to the retailer for providing coupon A to the consumer. Expected value 60 may not accurately reflect an absolute expected value of coupon 52, but, more importantly, provides an expected value relative to other coupons in correlation data structure 42.

Correlation data structure 42 of FIG. 4 shows three predictor sets 56 for each coupon, with each predictor set linked to one redemption frequency 58 and one expected value 60. However, any number of predictor sets may be associated with a coupon in correlation data structure 42. The number of predictor sets associated with each coupon of correlation data structure 42 may be dependent upon available computing power of processor 18 and the size of a transaction database used to generate correlation data structure 42. In addition, the number of predictor sets for each coupon may be determined by a threshold expected value or support (see below) that must be exceeded for inclusion of predictor set 56 in correlation data structure 42.

In some current transactions, there may be more than one predictor set 56 satisfied for a coupon. Multiple expected values 60 for a single coupon are typically converted to one expected value. For example, if a current transaction includes items D-H, analysis of the transaction by processor 18 would identify predictor sets {D, E, F} and {G, H} for coupon A in basket 20. Thus coupon A would have more than one expected value, $0.20 and $0.14 in this example. Any suitable approach may be used to convert multiple expected values 60 of a coupon to a single expected value 60. For example, multiple expected values 60 for a single coupon may be pared by selecting the largest expected value, using the sum of the expected values 60, or by taking a weighted sum or other function of expected values.

Redemption frequency 58 may be provided by any suitable approach that correlates the purchase of predictor set 56 in the current transaction with subsequent coupon redemption. Typically, redemption frequencies result from association rules. Association rules analyze a set of transactions to describe the percentage of transactions in which a set of items are found to occur together in a transaction relative to a subset of the set. This percentage is termed a confidence of association. Generally, these rules result from an analysis of a large set of transactions. An association rule would be derived as follows. If 40% of transactions with items D, E, and F also include item A, then an association rule states that a transaction with set {D, E, F}, termed an antecedent, will also include item A, termed a consequent, with a confidence of 40%. The support for the confidence is the frequency with which a set that includes items A, D, E, and F is found in all transactions considered. For example, if 2% of transactions include items A, D, E, F, the rule described above has a support of 2%. Typically, an association rule must have a support above a minimum level, referred to as a minimum support, to be described as a relevant association rule. Techniques for generating association rules from transaction databases were incorporated by reference earlier and are applicable here.

In the present invention, the confidence provided by an association rule for a coupon item may be used as an estimate of coupon redemption frequency 58 for the coupon. Thus, in the example presented above and shown in FIG. 4, the confidence of 40% for item A, derived from analysis of a set of prior transactions, may be equated to redemption frequency 58 of the coupon for item A (coupon A), based on predictor set {D, E, F}. Thus, when predictor set {D, E, F} occurs in a transaction, a redemption frequency of 40% is assigned to coupon A, based on the confidence of 40% for item A association with items D, E, and F.

Another suitable approach provides redemption frequency 58 for coupon 52 by analyzing sequential transaction behavior of identified consumers, rather than with association rules from anonymous consumers. For example, if 40% of consumers that purchase items D, E, and F in an initial transaction are found to purchase item A in a subsequent transaction, redemption frequency 58 may be characterized as 40%. Since redemption frequency 58 is intended to be useful in predicting the redemption rate of a coupon, a predicting contribution of each subsequent transaction may be weighted based on its temporal-relatedness to the initial transaction. A consideration of the time at which a subsequent transaction takes place relative to the initial purchase might weight transactions to favor those in which the consumer would be more likely to use a coupon.

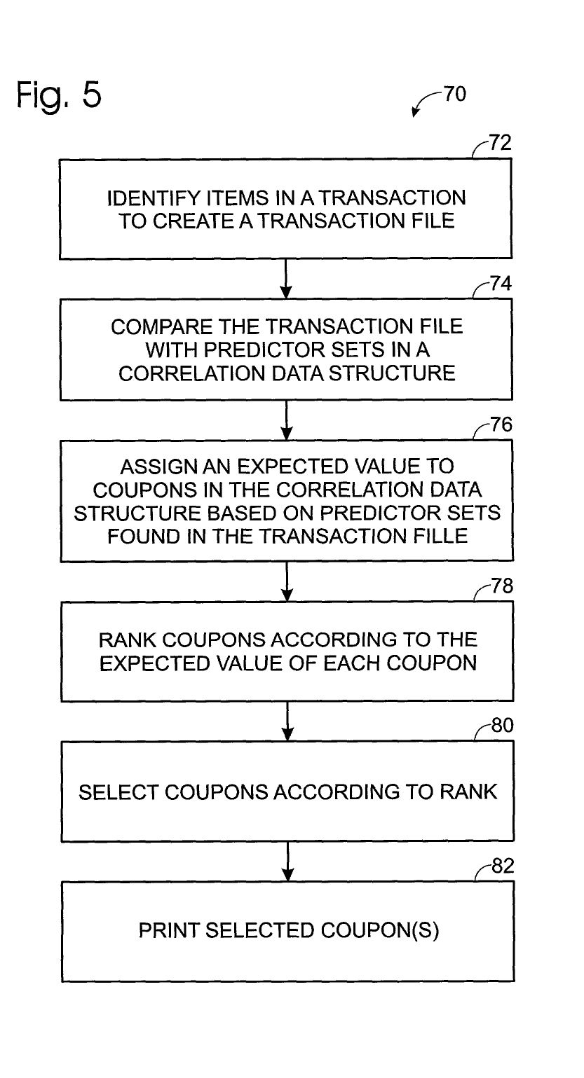

FIG. 5 is a method, shown generally at 70, for providing coupons in accordance with the invention. In an initial step 72, items 12 in a transaction are identified to create a transaction file 40 corresponding to the present basket 20. Typically, identifying step 72 uses scanner 14 and generalizes an identity of each item.

In a subsequent step 74, transaction file 40 is compared with predictor sets 56 in a correlation data structure 42. This comparing step 74 determines if one or more predictor sets for each coupon 52 are contained within transaction file 40, and thus basket 20. When a predictor set 56 is found in transaction file 40, a linked expected value 60 is assigned to coupon 52 in step 76. If no predictor set 56 of the coupon is found in transaction file 40, the coupon is assigned a default expected value 60, typically zero. Alternatively, when no predictor sets are identified, the coupon may be assigned a coupon-specific default expected value 60 that is dependent upon an importance of the coupon, for example an expected value 60 proportional to benefit 54. As described above, if more than one predictor set 56 for the coupon is found in transaction file 40, a single final expected value 60 is usually derived from the multiple assigned expected values 60.

When all coupons have been assigned expected value 60, the coupons are ranked to give each a priority rank according to the expected value of each coupon, as shown at step 78. The priority rank of the coupons provides an order in which the coupons will be selected at step 80. Typically, priority ranks are ordered from highest to lowest priority, where the highest priority coupon is selected first at step 80, and each additional coupon selected is a highest of all unselected coupons. When coupons have equal expected values 60, (e.g. when no predictor sets 56 were found in transaction file 40), one or more coupons may be selected at random, or in accordance with some other coupon selection convention.

Multiple coupons may be selected, the number of coupons being selected through any one of various strategies. For example, the number may be constant, each consumer receiving the same number of coupons. Alternatively, the number of coupons printed may be based on a threshold minimum expected value. In this case, transaction record 24 will include a coupon if expected value 60 for the coupon is above the threshold. The number of selected or printed coupons may also be determined by a property of the current transaction. For example, the property may be total transaction price, total number of items, or a property of the consumer such as gender.

Each coupon selected at step 80 is printed at step 82. Typically printing occurs directly on transaction record 24, either on front side 32 or back side 34. Each coupon selected may be linked to coupon image file 44. Processor 18 thus may retrieve coupon image file 44 and send the image file 44 to printer 22 for printing. Alternatively, some or all of coupon image files 44 may be stored in memory of printer 22 and may be retrieved from memory for printing step 82. Furthermore, the coupon may be printed as straight text, without an image. Whatever the form of coupon 30, printer 22 makes a hard copy of the coupon by printing the coupon in association with transaction record 24. Expected value 60 may determine appearance of coupon 30. Appearance is any aspect of coupon 30 other than product identity, and may include size, quality, spacing, position, orientation, or color selection of coupon 30. For example, when a coupon has a very high expected value 60, the coupon may occupy a larger area of transaction record 24, may be printed at higher resolution, or may include a larger number of colors than a coupon with lower expected value 60.

Typically, method 70 relies on a real-time analysis of correlation data structure 42. The present invention may provide additional flexibility in its structure and implementation to allow the real-time analysis to be performed efficiently. For example, correlation data structure 42 may have a size that is readily altered by changing the number of coupons or a threshold requirement for support (of an association rule), benefit 54, redemption frequency 58, or expected value 60 in order to be included in correlation data structure 42. Generally, the size of correlation data structure 42 is selected based on capabilities of processor 18.

The disclosure set forth above encompasses multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the inventions includes all novel and nonobvious combinations and subcombinations of the various elements, features, functions, and/or properties disclosed herein. The following claims particularly point out certain combinations and subcombinations regarded as novel and nonobvious and directed to one of the inventions. These claims may refer to “an” element or “a first” element or the equivalent thereof; such claims should be understood to include incorporation of one or more such elements, neither requiring nor excluding two or more such elements. Inventions embodied in other combinations and subcombinations of features, functions, elements, and/or properties may be claimed through amendment of the present claims or through presentation of new claims in this or a related application. Such claims, whether directed to a different invention or to the same invention, and whether broader, narrower, equal, or different in scope to the original claims, also are regarded as included within the subject matter of the inventions of the present disclosure.

I claim:

1. A method of providing coupons, the method comprising the steps of:
identifying items in a current transaction;
assigning an expected value to each coupon of a coupon set based on a comparison of the identified items with a predictor set that links expected value to each coupon of the coupon set;
selecting a coupon from the coupon set based on the expected value of the coupon; and
printing the selected coupon.

2. The method of claim 1, further including the step of ranking each coupon of the coupon set to give each coupon a priority rank based on the assigned expected value.

3. The method of claim 2, where selection of a coupon is made based on priority rank.

4. The method of claim 1, where plural coupons are selected and printed.

5. The method of claim 4, where a number of coupons to be printed is selected based on quantity of items in the current transaction.

6. The method of claim 4, where a number of coupons to be printed is selected based on total price of items in the current transaction.

7. The method of claim 1, where printing occurs on a transaction record.

8. The method of claim 1, where printed coupon appearance changes based on expected value.

9. The method of claim 1, where printed coupon appearance changes based on quantity of items in the current transaction.

10. The method of claim 1, where printed coupon appearance changes based on total price of items in the current transaction.

11. A method of selecting a coupon for presentation, the method comprising the steps of:
identifying items in a current transaction;
assigning an expected value to each coupon of a coupon set based on a comparison of the identified items with a value predictor set that relates each coupon to a benefit received by transacting a subject item of such coupon; and
selecting a coupon based on the expected value of the coupon.

12. The method of claim 11, where the benefit received is profit for selling a subject item upon coupon redemption.

13. The method of claim 11, where the predictor set determines a redemption frequency, and the expected value is a product of the redemption frequency multiplied by the benefit.

14. The method of claim 13, where the redemption frequency is substantially equal to a confidence of an association rule.

15. A system for printing coupons, comprising:
an input device configured to identify items in a current transaction;
a processor that includes a correlation data structure in which each coupon of a coupon set is linked to a predictor set and an expected value, where the processor is operatively connected to the input device and configured to create a transaction file from the identified items, to assign the expected value to each coupon of the coupon set based on a comparison of the transaction file with the predictor set of each coupon, and to select a coupon of the coupon set based on the expected value of the coupon; and
a printer operatively connected to the processor and configured to print the coupon selected by the processor.

16. The system of claim 15, where the processor is further configured to rank each coupon of the coupon set to give each coupon a priority rank based on the assigned expected value.

17. The system of claim 16, where the processor selects the coupon based on the priority rank of the coupon.

18. The system of claim 15, where the expected value is at least partially determined by a benefit received by transacting a subject item of each coupon.

19. The system of claim 15, where the expected value is related to a redemption frequency determined by the predictor set.

20. The system of claim 19, where the redemption frequency is substantially equal to a confidence of an association rule.

21. A processor for assigning an expected value to coupons, comprising:
a site for receiving item identification and configured to create a transaction file in memory from the item identification;
a correlation data structure contained in memory and including a coupon set, where each coupon of the coupon set is linked to a predictor set and an expected value; and
instructions configured to compare the transaction file with the predictor set and to assign the expected value to a coupon of the coupon set when the predictor set of the coupon is included in the transaction file.

22. The processor of claim 21, where the instructions are further configured to rank each coupon of the coupon set to give each coupon a priority rank based on the assigned expected value.

23. The processor of claim 22, where the processor selects the coupon based on the priority rank of the coupon.

24. The processor of claim 21, where the expected value is at least partially determined by a benefit received by transacting a subject item of each coupon.

25. The processor of claim 21, where the expected value is related to a redemption frequency determined by the predictor set.

26. The processor of claim 25, where the redemption frequency is substantially equal to a confidence of an association rule.

27. The processor of claim 21, further comprising a coupon image file for the coupon.
